(19) United States
(12) Patent Application Publication
(10) Pub. No.: US 2026/0216600 A1
(43) Pub. Date: Jul. 30, 2026

(54) ONE OR MORE NON-TRANSITORY COMPUTER-READABLE STORAGE MEDIA, INFORMATION PROCESSING SYSTEM, AND COMPUTER-IMPLEMENTED METHOD

(71) Applicant: NINTENDO CO., LTD., Kyoto (JP)

(72) Inventors: Jyunya OSADA, Kyoto (JP); Atsuko ASAHI, Kyoto (JP); Maasa MIYOSHI, Kyoto (JP)

(21) Appl. No.: 19/453,470

(22) Filed: Jan. 20, 2026

(30) Foreign Application Priority Data
Jan. 24, 2025 (JP) 2025-010520

(51) Int. Cl. A63F 13/54; A63F 13/803

(52) U.S. Cl. CPC A63F 13/54; A63F 13/803; A63F 2300/638

(57) ABSTRACT

In a game according to an exemplary embodiment, an intra-base route set corresponding to each of a plurality of base areas and an inter-base route connecting the base areas are set on a field, and a first game is performed on a course including the inter-base route and the intra-base routes. In the first game, while a player object is running the inter-base route, a composition included in a first game playlist corresponding to a base area including a starting point of the inter-base route is reproduced as BGM. In the first game, while the player object is running an intra-base route in a base area, a stage corresponding composition corresponding to the base area is reproduced as BGM.

### CROSS REFERENCE TO RELATED APPLICATION

This application claims priority to Japanese Patent Application No. 2025-010520 filed on January 24, 2025, the entire contents of which are incorporated herein by reference.

### FIELD

An exemplary embodiment relates to one or more non-transitory computer-readable storage media having stored therein a game program, an information processing system, a computer-implemented method, and an information processing apparatus that enable the execution of a racing game.

### BACKGROUND AND SUMMARY

Conventionally, there is a game where a race is performed at each of a plurality of stages, and BGM according to the stage is output during the race.

In the above conventional game, BGM is selected with respect to each stage.

An exemplary embodiment discloses a game program, an information processing system, a computer-implemented method, and an information processing apparatus that are capable of varying the selection of BGM in a racing game where a race is performed on courses set at various locations on a field.

The exemplary embodiment employs the following configurations.

### First Configuration

A first configuration is one or more non-transitory computer-readable storage media having stored therein instructions that, when executed, cause one or more processors to perform operations including causing an operating object to run on a field in a virtual space based on an operation input. The operations include, in a first mode where a first type of race is performed by the operating object and at least one other movable object on any of a plurality of types of courses at least including an intra-base route that is a path set in any of a plurality of base areas set on the field and an inter-base route set as a path connecting the base areas. The operations include, while the operating object is running the inter-base route, reproducing as BGM a composition included in a first playlist selected based on a location in the inter-base route among a plurality of first types of playlists. The operations include, while the operating object is running the intra-base route, reproducing as BGM a second type of composition selected based on the base area corresponding to the intra-base route or a composition included in a second playlist among a plurality of second types of compositions or a second type of playlist.

Based on the above, a composition included in a first playlist selected based on a location in an inter-base route is reproduced as BGM. Thus, for example, in a racing game where a race is performed on courses set at various locations on a field, it is possible to incorporate regionalities into the selection of BGM to be reproduced.

### Second Configuration

According to a second configuration, in the above first configuration, the operations may further include, in the first mode, while the operating object is running the inter-base route, when in-game time is a first period of time, reproducing as BGM a composition included in the first playlist, and when the in-game time is a second period of time, reproducing as BGM a composition included in a third playlist.

Based on the above, it is possible to further select BGM according to a period of time.

### Third Configuration

According to a third configuration, in the above second configuration, the operations may further include, in the first mode, while the operating object is running the inter-base route, after reproducing a predetermined number of compositions included in the first playlist, when the in-game time is the first period of time, reproducing as BGM a composition included in a fourth playlist, and when the in-game time is the second period of time, reproducing as BGM a composition included in the third playlist.

Based on the above, it is possible to further vary in the selection of BGM.

### Fourth Configuration

According to a fourth configuration, in any of the above first to third configurations, the operations may further include selecting the first playlist in accordance with the base area corresponding to a start position of the inter-base route among the first types of playlists.

Based on the above, it is possible to select a first playlist in accordance with a start position of the inter-base route.

### Fifth Configuration

According to a fifth configuration, in any of the above first to fourth configurations, the operations may further include, in a second mode where the operating object is caused to run on the field, regardless of a course, when in-game period of time is a first period of time, reproducing as BGM a composition included in a fifth playlist, and when the in-game period of time is a second period of time, reproducing as BGM a composition included in a sixth playlist.

Based on the above, it is possible to perform a game in a first mode where a first type of race is performed, and a second mode where an operating object is caused to run on a field common to in the first mode and the second mode. Thus, it is possible to set BGM to be reproduced during a game in view of both a regionality and a period of time in accordance with the mode.

### Sixth Configuration

According to a sixth configuration, in any of the above first to fifth configurations, the operations may further include, in a third mode where a second type of race is performed on a course at least including the plurality of continuous inter-base routes, while the operating object is running each of the inter-base routes, reproducing as BGM the second type of composition or a composition included in the second playlist according to the base area corresponding to a start position of the inter-base route.

Based on the above, in a game in a third mode, it is possible to continuously reproduce compositions according to a base area. It is possible to further vary the selection of BGM.

### Seventh Configuration

According to a seventh configuration, in any of the above first to sixth configurations, the operations may further include, in a fourth mode where a third type of race is performed on a course where the operating object and the at least one other movable object take a predetermined number of laps around the intra-base route, reproducing as BGM the second type of composition or a composition included in the second playlist according to the base area corresponding to the intra-base route.

Based on the above, it is possible to perform a third type of race on a course where movable objects take a predetermined number of laps around an intra-base route. It is possible to reproduce a composition according to a base area corresponding to an intra-base route as BGM.

### Eighth Configuration

According to an eighth configuration, in any of the above first to seventh configurations, the operations may further include: controlling the at least one other movable object based on data of another player acquired based on communication to perform the first type of race as a competition against the other player; and in the first type of race, transmitting a playlist that is being selected and reproduced part data indicating a part that is being reproduced in the playlist, or reproducing the BGM based on the received reproduced part data.

Based on the above, in a case where a player performs a first type of race with another player based on communication, it is possible to share a playlist and reproduced part data. It is possible to reproduce a common composition as BGM.

Another configuration may be an information processing system that executes the above game program, or may be an information processing apparatus, or may be a computer-implemented method.

According to the exemplary embodiment, in a racing game where a race is performed on courses set at various locations on a field, it is possible to incorporate regionalities into the selection of BGM to be reproduced.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting diagram showing an example of a field in a virtual space;

FIG. 4 is an example non-limiting diagram showing examples of the types of games that can be executed by a game program according to the exemplary embodiment and BGM during the execution of each game;

FIG. 5 is an example non-limiting diagram showing an example of a course where a first game is performed;

FIG. 6 is an example non-limiting diagram showing examples of stage corresponding compositions corresponding to base areas;

FIG. 7 is an example non-limiting diagram showing an example of BGM to be output in a case where the first game is performed on the course exemplified in FIG. 5;

FIG. 8 is an example non-limiting diagram showing an example of a playlist PL_A1;

FIG. 9 is an example non-limiting diagram showing examples of a plurality of first game playlists;

FIG. 10 is an example non-limiting diagram showing examples of a plurality of compositions included in a playlist PL_N;

FIG. 11 is an example non-limiting diagram showing an example of a third game playlist;

FIG. 12 is an example non-limiting diagram showing an example of a course of a fourth game;

FIG. 13 is an example non-limiting diagram showing an example of BGM to be output in a case where the fourth game is performed on the course shown in FIG. 12;

FIG. 14 is an example non-limiting diagram showing examples of various pieces of data used in game processes;

FIG. 15 is an example non-limiting flow chart showing an example of a first game process regarding the first game;

FIG. 16 is an example non-limiting flow chart showing an example of a second game process regarding a second game;

FIG. 17 is an example non-limiting flow chart showing an example of a third game process regarding a third game; and

FIG. 18 is an example non-limiting flow chart showing an example of a fourth game process regarding the fourth game.

### DETAILED DESCRIPTION OF NON-LIMITING EXAMPLE EMBODIMENTS

### Game System Configuration

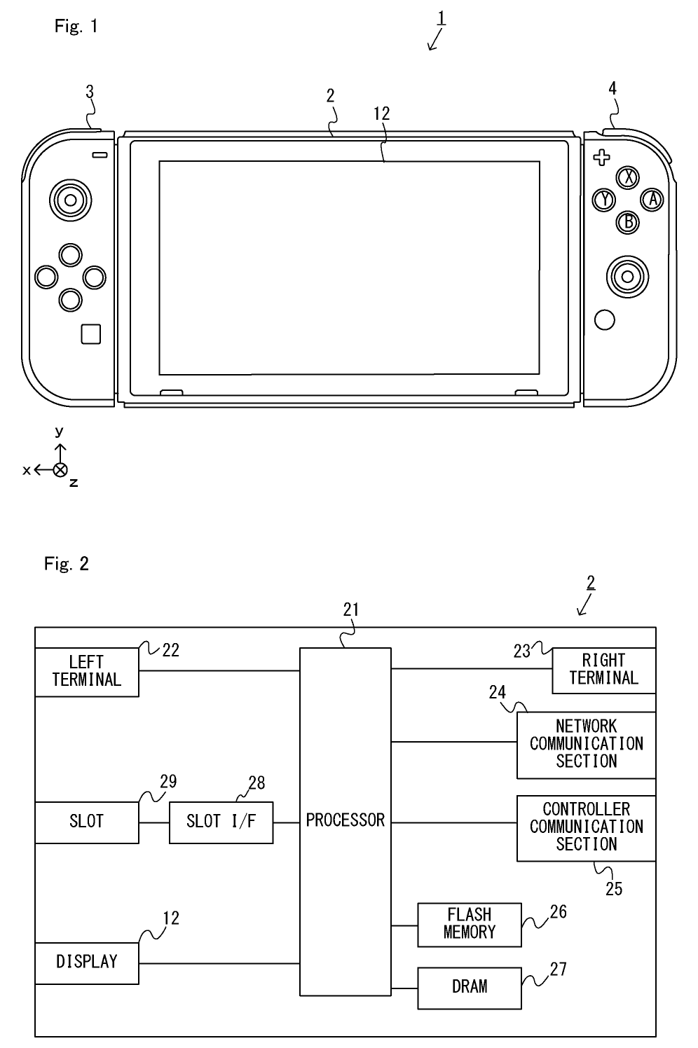

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of buttons (an A-button, a B-button, an X-button, and a Y-button) and an analog stick, as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a "controller".

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as "I/F") 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi (registered trademark) standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called "local communication" in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### Overview of Game

Next, an overview of a game executed in the game system 1 is described. A game according to the exemplary embodiment is a racing game where a plurality of movable objects are caused to run on a field in a virtual space (a game space).

For example, the movable objects include a vehicle object and a character object on the vehicle object. For example, the vehicle object is an object that moves on the ground, such as a vehicle, a motorcycle, a bicycle, a horse, or a runner. The vehicle object is not limited to an object that moves on the ground, and may be an object that moves on water or under water, such as a ship, a boat, or a submarine. A movable object may be an object that moves in the air, such as an airplane, a helicopter, or a glider. A movable object may be a character itself.

Here, the modes of the game are described. In the exemplary embodiment, there are a single-play mode where the game is performed by a single-player, and a multiplay mode where the game is performed by a plurality of players.

In the single-play mode, a player of the main body apparatus 2 operates a single movable object using the controllers 3 and/or 4. Here, the movable object operated by the player of the main body apparatus 2 is referred to as a "player object". The player object is an example of an operating object. If the racing game is performed in the single-play mode, the processor 21 of the main body apparatus 2 automatically controls one or more movable objects.

The multiplay mode includes an offline multiplay mode and an online multiplay mode. The offline multiplay mode is a mode where a plurality of controllers are connected to a single main body apparatus 2, or a plurality of main body apparatuses 2 are connected together via a wireless or wired LAN or the like, and a plurality of players perform the game. The plurality of players control movable objects corresponding to the plurality of players themselves using controllers.

In the online multiplay mode, a plurality of main body apparatuses 2 are connected to the Internet. Players control movable objects corresponding to the players themselves using controllers. For example, each main body apparatus 2 receives other movable object information regarding the other movable objects corresponding to the other players (information indicating the positions, the orientations, the velocities, the moving directions, and the like of the other movable objects) from the other main body apparatuses 2 via the Internet. The main body apparatus 2 transmits player object information regarding the player object corresponding to the player of the main body apparatus 2 itself (information indicating the position, the orientation, the velocity, the moving direction, and the like of the player object) to the other main body apparatuses 2. On the same course, each main body apparatus 2 controls the player object corresponding to the player of the main body apparatus 2 itself and also controls the other movable objects corresponding to the other players based on the other movable object information from the other main body apparatuses.

Here, a movable object operated by another player or a movable object controlled by the processor 21 in the single-play mode or the multiplay mode is referred to as "another movable object".

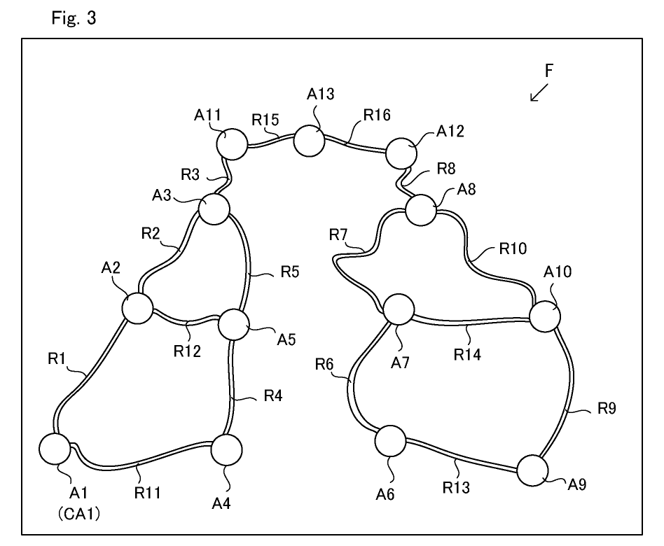

Next, a description is given of the field where the game according to the exemplary embodiment is performed. FIG. 3 is a diagram showing an example of the field in the virtual space where the game according to the exemplary embodiment is performed.

As shown in FIG. 3, a plurality of base areas A (A1 to A13 in FIG. 3) are set on a field F in the virtual space. Each base area A is an area which is placed at predetermined positions in the virtual space and where the plurality of movable objects can race. Although each base area A is represented as a circle in FIG. 3, in each base area A, an intra-base route CA indicating a path where the plurality of movable objects move in the race is set. For example, in the base area A1, an intra-base route CA1 is set. In the base area A2, an intra-base route CA2 is set. Each base area A (each intra-base route CA) is also referred to as a "stage".

A plurality of base areas are linked together by inter-base routes R (e.g., R1 to R16) indicating paths where the plurality of movable objects move in the race. For example, the base areas A1 and A2 are linked together by the inter-base route R1. The base areas A1 and A4 are linked together by the inter-base route R11.

In a game program according to the exemplary embodiment, a racing game where the plurality of movable objects race on a course including one or more inter-base routes R and intra-base routes CA can be executed. In the game program according to the exemplary embodiment, a racing game where the plurality of movable objects race on a course using an intra-base route CA can be executed.

A description is given below of a plurality of types of games that can be executed by the game program according to the exemplary embodiment, and a description is also given of control of BGM (Background Music) output during each game.

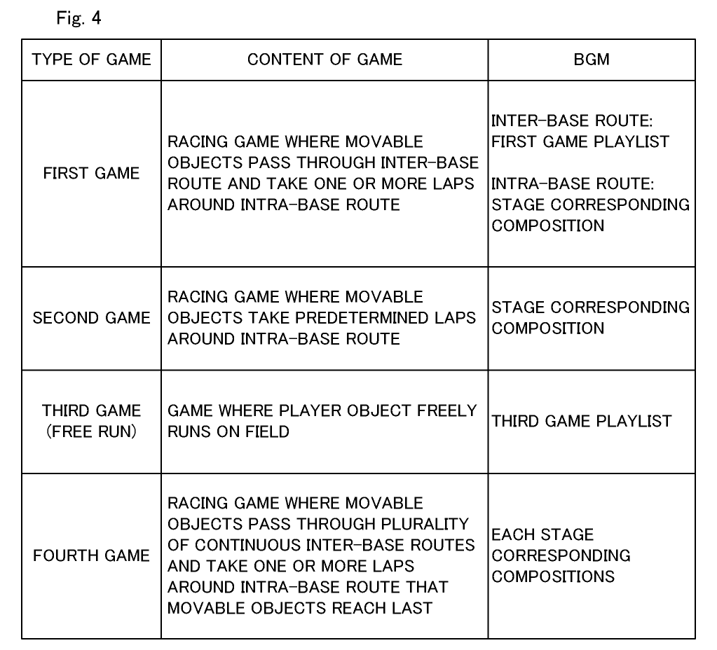

FIG. 4 is a diagram showing examples of the types of games that can be executed by the game program according to the exemplary embodiment and BGM during the execution of each game. As shown in FIG. 4, the game program according to the exemplary embodiment can execute a plurality of types of games including first to fourth games.

The first game is a racing game performed on a course including an inter-base route R and an intra-base route CA. Specifically, the first game is a racing game where the plurality of movable objects start from a certain base area, pass through an inter-base route, enter another base area, take a predetermined number of laps (e.g., one or more laps) around the intra-base route CA in the other base area, and reach a goal point. The first game can be executed in both the single-play mode and the multiplay mode (the offline multiplay mode or the online multiplay mode).

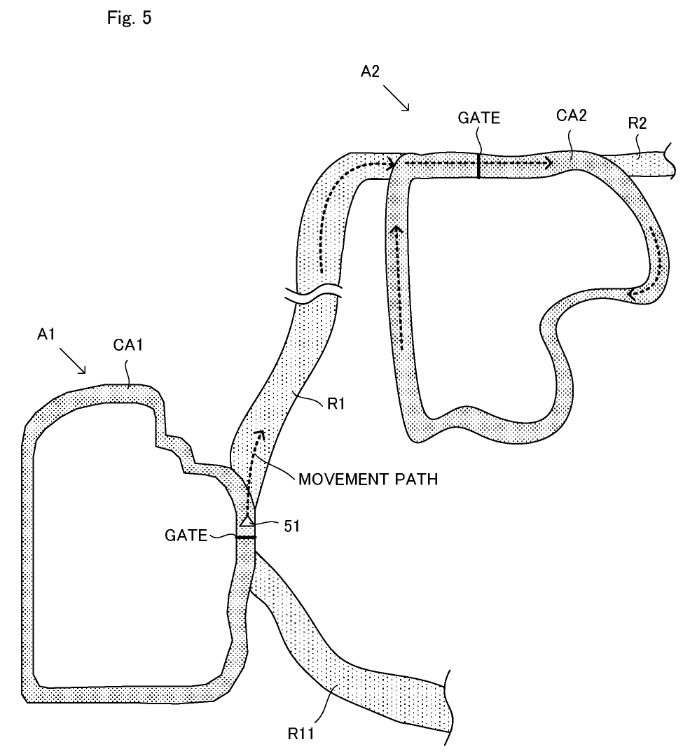

Here, an example of the course of the first game is described. FIG. 5 is a diagram showing an example of the course where the first game is performed.

As shown in FIG. 5, for example, the first game is performed on a course including the inter-base route R1 and the intra-base route CA2. Specifically, if the first game is performed using this course, a plurality of movable objects 51 including the player object start from a starting point (a gate) provided in the intra-base route CA1 in the base area A1, enter the inter-base route R1 without taking a lap (or by taking a lap) around the intra-base route CA1, pass through the inter-base route R1, and enter the base area A2. Then, the plurality of movable objects 51 take a predetermined number of laps (one or more laps) around the intra-base route CA2 in the base area A2 and reach a goal point (a gate) provided in the intra-base route CA2. The course shown in FIG. 5 is merely an example, and there is also a case where a course including another inter-base route and another intra-base route is set.

As shown in FIG. 4, in the first game, while the player object is running the inter-base route R, BGM is output based on a first game playlist. In the first game, while the player object is running the intra-base route CA, a stage corresponding composition is output. The stage corresponding composition is a composition corresponding to the base area A where the intra-base route CA that the player object is running is provided. For example, if the first game is performed on the course including the inter-base route R1 and the intra-base route CA2, and while the player object is running the inter-base route R1, BGM is output based on the first game playlist including a plurality of compositions. While the player object is running the intra-base route CA2, a stage corresponding composition corresponding to the base area A2 is output as BGM. The details of BGM during the first game will be described below.

The second game is a racing game performed in a base area and is a racing game where the plurality of movable objects take a predetermined number of laps (e.g., three laps) around an intra-base route CA. For example, if the second game is performed on the intra-base route CA2 shown in FIG. 5, the plurality of movable objects 51 start from the gate of the intra-base route CA2, take a predetermined number of laps around the intra-base route CA2, and reach the goal point (the gate) provided in the intra-base route CA2. The second game can be executed in both the single-play mode and the multiplay mode (the offline multiplay mode or the online multiplay mode).

In the exemplary embodiment, a stage corresponding composition corresponding to each base area is prepared in advance. During the execution of the second game, the stage corresponding composition corresponding to the base area where the second game is performed is output as BGM.

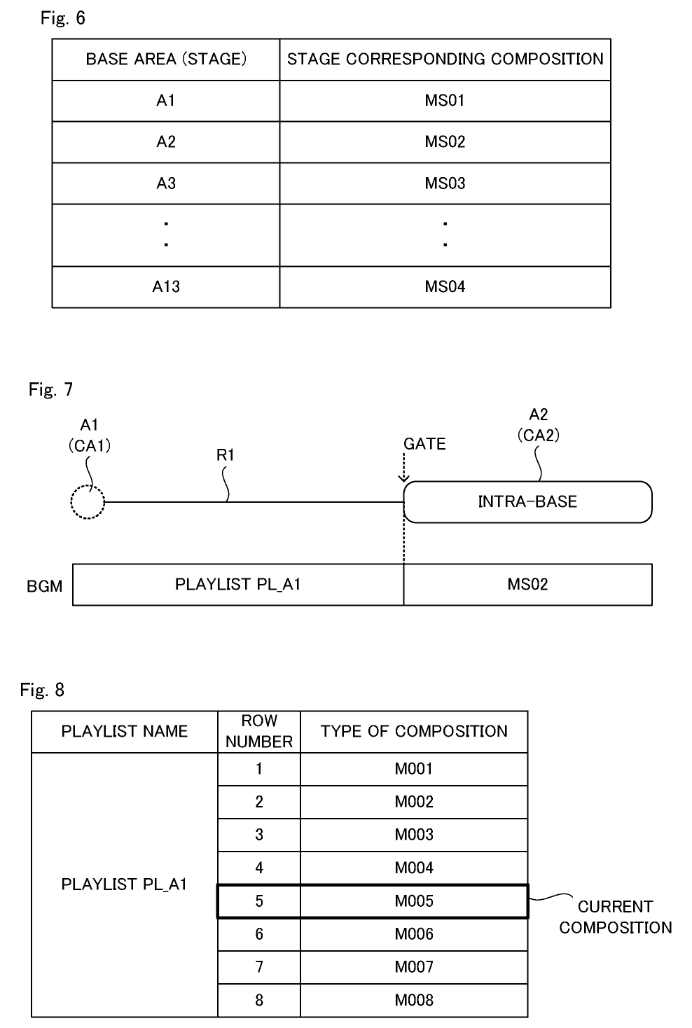

FIG. 6 is a diagram showing examples of the stage corresponding compositions corresponding to the base areas. As shown in FIG. 6, for example, a stage corresponding composition MS01 is a composition created exclusively for the base area A1 and is associated with the base area A1. A stage corresponding composition MS02 is a composition created exclusively for the base area A2 and is associated with the base area A2. A stage corresponding composition MS03 is a composition created exclusively for the base area A3 and is associated with the base area A3. For example, if the second game is performed on the course where the intra-base route CA2 is used, the stage corresponding composition MS02 is repeatedly output as BGM.

Referring back to FIG. 4, the third game is a game where the player object is caused to freely run on the field F. In the third game, a path on which the player object moves is not set, and the player object runs an intra-base route CA, runs an inter-base route R, or runs in any area (e.g., a grassland, a sandy place, a water surface, or the like where a road is not provided) on a field different from the intra-base route CA and the inter-base route R in accordance with an operation of the player. Here, the process of causing the player object to freely run on the field is referred to as "free run". The third game is executed in the single-play mode.

In a case where the third game is performed, BGM is output based on a third game playlist including a plurality of compositions. The details of the third game playlist will be described below.

The fourth game is a racing game where the plurality of movable objects pass through a plurality of continuous inter-base routes R, and take a predetermined number of laps (one or more laps) around an intra-base route CA that the plurality of movable objects reach last. The fourth game can be executed in both the single-play mode and the multiplay mode (the offline multiplay mode or the online multiplay mode). If the fourth game is performed, the stage corresponding composition corresponding to each base area is output as BGM. The details of the fourth game and BGM during the fourth game will be described below.

### Control of BGM during First Game

Next, BGM to be output during the first game is described. FIG. 7 is a diagram showing an example of BGM to be output in a case where the first game is performed on the course exemplified in FIG. 5. FIG. 7 shows the relationship between the position of the player object and BGM to be output during the first game.

As shown in FIG. 7, in the first game, if the plurality of movable objects including the player object start from the base area A1, BGM is output based on a playlist PL_A1. The playlist PL_A1 is a playlist corresponding to the base area A1. Here, the playlist is a list in which a plurality of compositions are arranged. The compositions are selected and reproduced in the order of storage in the playlist. While the player object runs the inter-base route R1, a composition is selected based on the playlist PL_A1, and the selected composition is reproduced and output as BGM.

FIG. 8 is a diagram showing an example of the playlist PL_A1.

As shown in FIG. 8, a plurality of compositions are arranged in the playlist PL_A1. The playlist PL_A1 has 8 rows and includes compositions having row numbers "1" to "8". The compositions having the row numbers "1" to "8" correspond to different types of compositions M001 to M008. While the player object is running the inter-base route R1, the compositions having the row numbers "1" to "8" are reproduced in the order of row numbers. Specifically, if BGM is output using the playlist PL_A1, first, any of the row numbers "1" to "8" is randomly selected as a current composition and reproduced. If the reproduction of the selected composition ends, the composition having the next row number is selected as the current composition and reproduced. For example, if the composition M005 having the row number "5" is selected first, and the reproduction of the composition M005 ends, the composition M006 having the row number "6" is selected next as the current composition and output as BGM. Further, if the reproduction of the composition M006 having the row number "6" ends, the composition M007 having the row number "7" is selected next as the current composition and output as BGM.

For example, the compositions M001 to M008 included in the playlist PL_A1 are compositions representing the regionality of the base area A1. For example, the field F is divided into a plurality of areas, and a regionality is set for each area. For example, a first area including the base area A1 may be an area related to the sea. A second area including the base area A10 may be an area related to snow. For example, the compositions M001 to M008 included in the playlist PL_A1 corresponding to the base area A1 may be compositions with tunes that remind the player of the sea.

As shown in FIG. 7, after the player object passes through the inter-base route R1, and while the player object runs the intra-base route CA2 in the base area A2, the stage corresponding composition MS02 is output as BGM. While the player object runs the intra-base route CA2, the stage corresponding composition MS02 is repeatedly reproduced.

Further, before the reproduction of the stage corresponding composition MS02 is started, a predictive track may be reproduced. After the predictive track ends, the reproduction of the stage corresponding composition MS02 may be started. For example, if the player object comes close to the base area A2 (e.g., if the player object reaches a predetermined position a predetermined distance closer to the stating point than the gate of the intra-base route CA2), the predictive track of the stage corresponding composition MS02 may be reproduced, and after the player object passes through the gate, the reproduction of the stage corresponding composition MS02 may be started. In another exemplary embodiment, before the player object reaches the base area A2 (e.g., before the player object passes through the gate of the intra-base route CA2), the reproduction of the stage corresponding composition MS02 may be started.

As described above, in the first game, the plurality of movable objects including the player object start from a certain base area, pass through an inter-base route R, move to another base area, and take a predetermined number of laps around the intra-base route CA in the other base area. In such a first game, while the player object is running the inter-base route R, the compositions included in the first game playlist are reproduced in order in accordance with the list and output as BGM. While the player object is running the intra-base route CA, a stage corresponding composition is repeatedly output as BGM.

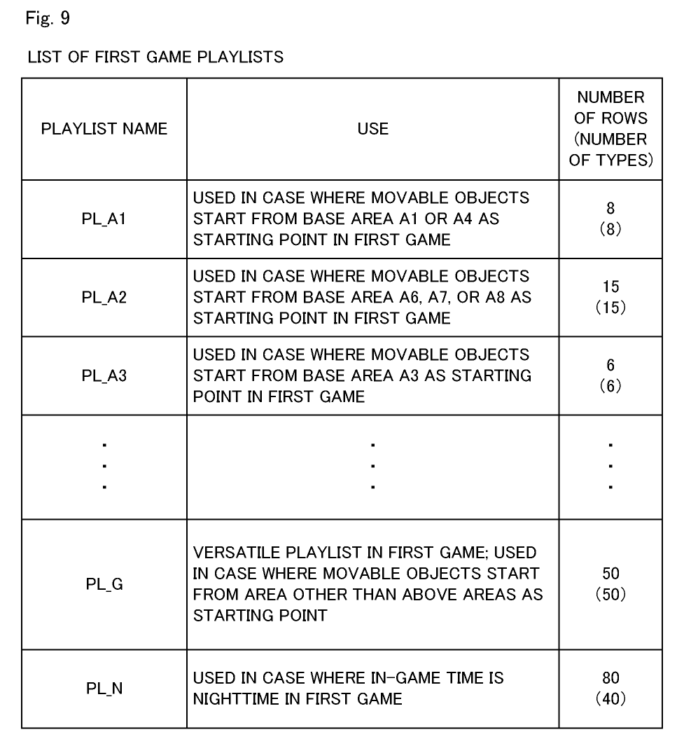

In the exemplary embodiment, a plurality of first game playlists are prepared in advance. FIG. 9 is a diagram showing examples of the plurality of first game playlists.

As shown in FIG. 9, in the exemplary embodiment, a playlist PL_A1, a playlist PL_A2, a playlist PL_A3, a playlist PL_G, and a playlist PL_N are prepared in advance as the first game playlist. These playlists are used while the player object is running an inter-base route R in the first game.

The playlist PL_A1 is a playlist corresponding to the base areas A1 and A4 and is a playlist used in a case where the first game is performed on a course where the base area A1 or A4 is a starting point. For example, the base areas A1 and A4 are areas related to the sea. The playlist PL_A1 has 8 rows, and as described above, for example, includes eight types of compositions (M001 to M008) that remind the player of the sea.

For example, if the first game is performed on a course where the plurality of movable objects start from the base area A1 as a starting point, move from the base area A1, pass through the inter-base route R1, and move to the base area A2, and while the player object is running in the base area A1 or the inter-base route R1, the playlist PL_A1 is used to select BGM. If the first game is performed on a course where the plurality of movable objects start from the base area A1 as a starting point, move from the base area A1, pass through the inter-base route R11, and move to the base area A4, and while the player object is running in the base area A1 or the inter-base route R11, the playlist PL_A1 is used to select BGM. For example, if the first game is performed on a course where the plurality of movable objects start from the base area A4 as a starting point, move from the base area A4, pass through the inter-base route R4, and move to the base area A5, and while the player object is running in the base area A4 or the inter-base route R4, the playlist PL_A1 is used to select BGM. For example, if the first game is performed on a course where the plurality of movable objects start from the base area A4 as a starting point, move from the base area A4, pass through the inter-base route R11, and move to the base area A1, and while the player object is running in the base area A4 or the inter-base route R11, the playlist PL_A1 is used to select BGM.

The playlist PL_A2 is a playlist corresponding to the base areas A6, A7, and A8 and is a playlist used in a case where the first game is performed on a course where the base area A6, A7, or A8 is a starting point. For example, the playlist PL_A2 has "15" rows and includes 15 types of compositions. The base areas A6, A7, and A8 also have similar regionalities. The plurality of compositions included in the playlist PL_A2 are compositions with tunes corresponding to the regionalities. Also if BGM is output using the playlist PL_A2, similarly to the above, any of the row numbers "1" to "15" is randomly selected first as the current composition, and if the reproduction of the selected composition ends, the composition having the next row number is selected as the current composition and reproduced.

The playlist PL_A3 is a playlist corresponding to the base area A3 and is a playlist used in a case where the first game is performed on a course where the base area A3 is a starting point. For example, the playlist PL_A3 has "6" rows and includes six types of compositions.

The playlists PL_A1 to A3 are playlists corresponding to a base area where a starting point of the first game is placed. Here, such a playlist corresponding to a base area is referred to as a "base corresponding playlist". In addition to the playlists PL_A1 to A3, a base corresponding playlist corresponding to each base area may be prepared in advance.

The playlist PL_G is a playlist used in a versatile manner in the first game and is used in a case where a base area other than the above base areas is a starting point. Here, the playlist PL_G is occasionally referred to as a "versatile playlist". For example, the playlist PL_G has "50" rows and includes 50 types of compositions.

The playlist PL_N is a list used when the player object is running an inter-base route R in the first game, and is a playlist used when in-game time is night. In the game according to the exemplary embodiment, in-game time (0 o'clock to 24 o'clock) is set. The in-game time may be time different from the current time of a clock provided in the main body apparatus 2, and advances in accordance with the lapse of time. For example, the in-game time may be divided into morning, daytime, evening, and night. For example, the playlist PL_N may be used when the in-game time is 19 o'clock to 3 o'clock. For example, the playlist PL_N has "80" rows and includes 40 types of compositions.

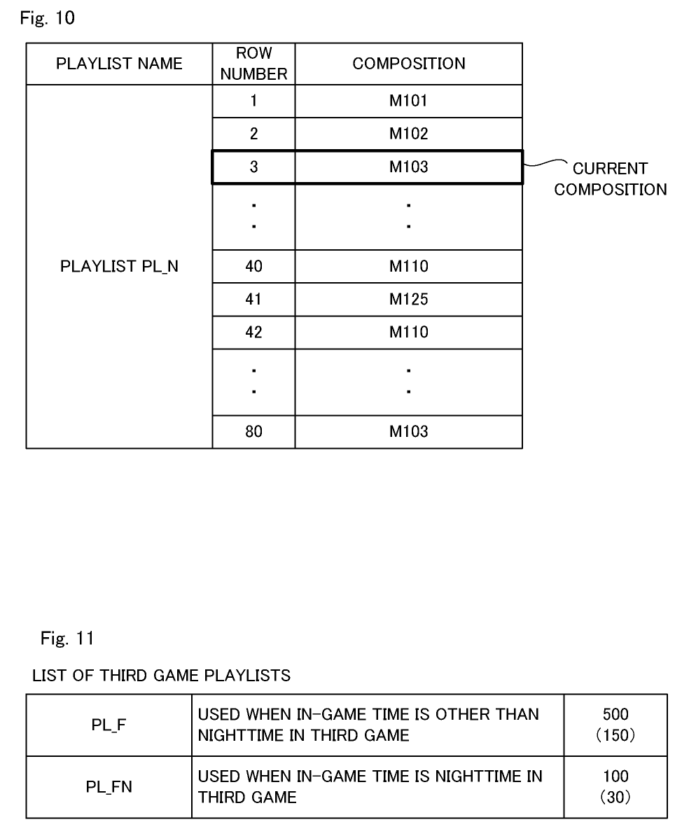

FIG. 10 is a diagram showing examples of the plurality of compositions included in the playlist PL_N. As shown in FIG. 10, in the playlist PL_N, compositions having row numbers "1" to "80" are arranged in order. The compositions having the row numbers "1" to "40" correspond to 40 types of compositions M101 to M140 different from each other. In the row numbers "41" to "80", these 40 types of compositions (the compositions M101 to M140) are arranged in a different order. For example, the row number "41" is associated with the composition M125, and the row number "42" is associated with the composition M110. If BGM is output using the playlist PL_N, any of the row numbers "1" to "80" is randomly selected first as the current composition and reproduced. If the reproduction of the selected composition ends, the composition having the next row number is selected as the current composition and reproduced. Different types of compositions are randomly arranged in a playlist, and the compositions are reproduced in the order of row numbers, whereby it is possible to reproduce various compositions in different orders and output the various compositions as BGM.

There is a case where the in-game time changes while the player object is running an inter-base route R. For example, there is a case where the in-game time changes from evening to nighttime while a composition included in the playlist PL_A1 is being reproduced. In this case, after the composition that is being reproduced ends, the playlist used to select BGM is changed from the playlist PL_A1 to the playlist PL_N.

As described above, if the in-game time is other than nighttime during the first game, and while the player object is running an inter-base route R, BGM is output using the base corresponding playlist corresponding to a base area including a starting point of the inter-base route R. Consequently, it is possible to incorporate regionalities into the selection of BGM to be output.

If the first game is performed in succession, there is a case where the same playlist is used in succession to select BGM. For example, if the first game is repeatedly performed using an area related to the sea (the base area A1 or A4) as a starting point, the playlist PL_A1 is used in succession. In this case, the same composition is output as BGM multiple times in a short period, or the order of BGM to be output is the same. To prevent such a situation, in the exemplary embodiment, if the same base corresponding playlist is used a predetermined number of times in succession, the versatile playlist is used next. For example, a case is assumed where the first game is performed in succession using an area related to the sea as a starting point. In this case, while the player object is running an inter-base route R, BGM is selected using the playlist PL_A1. For example, if the playlist PL_A1 is used four times in succession, and even if the first game is performed using an area related to the sea as a starting point next, and while the player object is running an inter-base route R, BGM is selected using the playlist PL_G. After the first game ends, and if the first game is further performed using an area related to the sea as a starting point, and while the player object is running an inter-base route R, BGM is selected using the playlist PL_A1. The playlist used to select BGM is thus changed, whereby it is possible to prevent the situation where the same composition is output as BGM multiple times in a short period, or the order of BGM to be output is the same.

There is a case where the playlists shown in FIG. 9 include the same types of compositions. For example, the playlist PL_A1 may include the compositions M01 to M08, but the playlist PL_A2 may also include any of the compositions M01 to M08. The playlist PL_G may include a composition included in another playlist.

Since the playlists include the same composition, there is a case where, in a case where the first game is performed in succession, and even if different playlists are used, the same composition is output as BGM in a relatively short period. In the exemplary embodiment, to prevent the same composition from being output as BGM in a relatively short period, the history of compositions output as BGM in a predetermined period in the past is stored as reproduced composition history. For example, 10 most recently reproduced compositions are stored as the reproduced composition history. Then, when a certain composition included in a playlist is selected as the current composition, and if the certain composition is included in the reproduced composition history, this composition is skipped, and the composition having the next number is selected as the current composition and reproduced.

Next, the third game playlist is described. FIG. 11 is a diagram showing an example of the third game playlist.

As shown in FIG. 11, for example, a playlist PL_F and a playlist PL_FN are prepared in advance as the third game (free run) playlist.

The playlist PL_F is a playlist used in a case where the in-game time is other than night in the third game. For example, the playlist PL_F has "500" rows and includes 150 types of compositions. If the in-game time is other than night during the third game, the plurality of compositions included in the playlist PL_F are selected in order and output as BGM. The details of the playlist PL_F are omitted.

The playlist PL_FN is a playlist used in a case where the in-game time is night in the third game. For example, the playlist PL_FN has "100" rows and includes 30 types of compositions. If the in-game time is night during the third game, the plurality of compositions included in the playlist PL_FN are selected in order and output as BGM. The details of the playlist PL_FN are omitted.

The third game playlist (the playlist PL_F or PL_FN) may include a composition included in the first game playlist (the playlists PL_A1 to A3, the playlist PL_G, or the playlist PL_N). For example, the third game playlist PL_FN used in a case where the in-game time is night may include a composition included in the first game playlist PL_N similarly used in a case where the in-game time is night. The third game playlist may not include a composition included in the first game playlist.

### Control of Fourth Game and BGM during Fourth Game

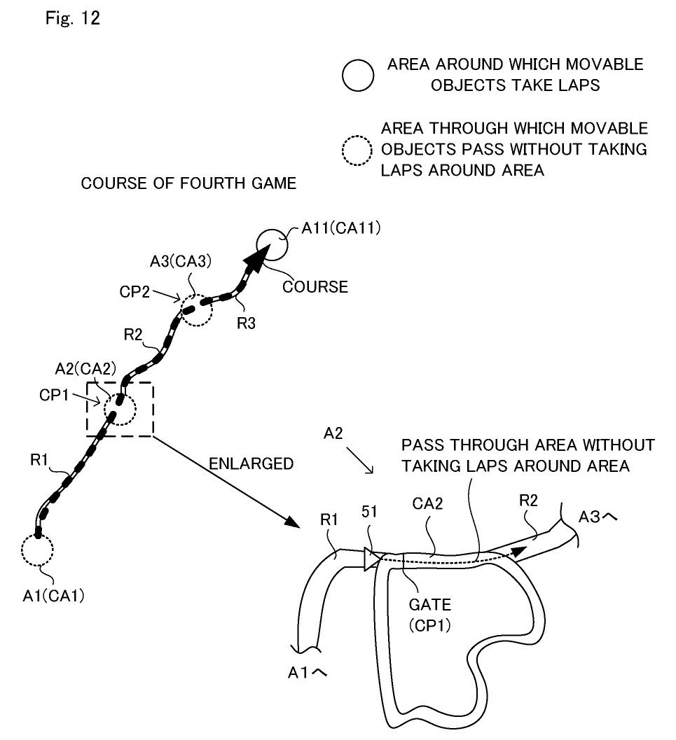

Next, the fourth game is specifically described. FIG. 12 is a diagram showing an example of a course of the fourth game.

As shown in FIG. 12, in the fourth game, for example, a course including the inter-base route R1, the inter-base route R2, the inter-base route R3, and an intra-base route CA11 is set. In the fourth game, for example, the plurality of movable objects including the player object start from the base area A1 (e.g., a gate of the intra-base route CA1), enter the inter-base route R1 without taking a lap (or by taking a lap) around the intra-base route CA1, pass through the inter-base route R1, and pass through a checkpoint CP1 of the base area A2 (e.g., a gate of the intra-base route CA2). After passing through the checkpoint CP1, the plurality of movable objects enter the inter-base route R2 without taking a lap (or by taking a lap) around the intra-base route CA2, pass through the inter-base route R2, and pass through a checkpoint CP2 (e.g., a gate of an intra-base route CA3) of the base area A3. After passing through the checkpoint CP2, the plurality of movable objects enter the inter-base route R3 without taking a lap (or by taking a lap) around the intra-base route CA3, pass through the inter-base route R3, and pass through a checkpoint CP3 (e.g., a gate of the intra-base route CA11) of the base area A11. At each checkpoint, a ranking determination is made, only movable objects having high rankings in the ranking determination pass through the checkpoint and continue the race, and movable objects having low rankings drop out of the race in the fourth game without passing through the checkpoint. Then, the plurality of movable objects passing through the checkpoint CP3 take a predetermined number of laps (e.g., one or more laps) around the intra-base route CA11 and reach a goal point (the gate) of the intra-base route CA11.

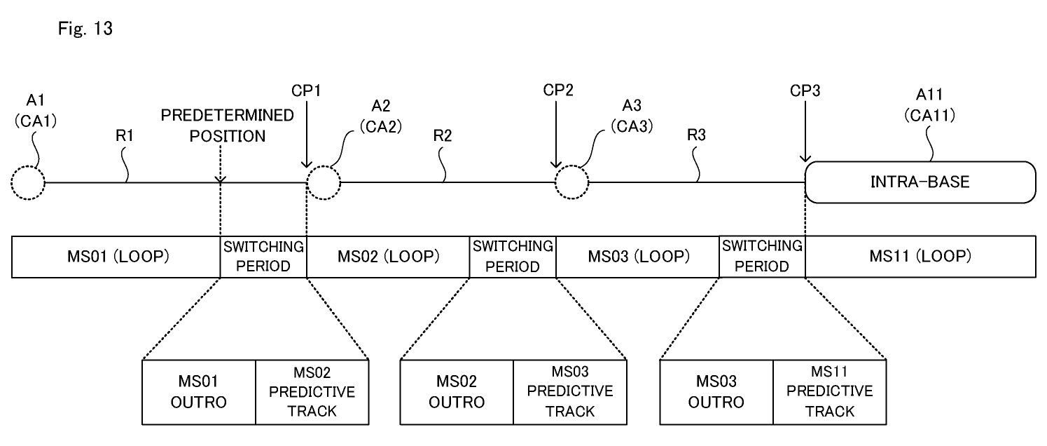

FIG. 13 is a diagram showing an example of BGM to be output in a case where the fourth game is performed on the course shown in FIG. 12. FIG. 13 shows the relationship between the position of the player object and BGM to be output during the fourth game. In FIG. 13, the description is given on the assumption that the player object passes through each checkpoint CP.

As shown in FIG. 13, for example, if the player object starts from the base area A1, the stage corresponding composition MS01 corresponding to the base area A1 is output as BGM. After the player object starts from the base area A1, and while the player object is running the inter-base route R1, the stage corresponding composition MS01 is repeatedly reproduced and output as BGM.

After the player object passes through the checkpoint CP1 of the base area A2, and while the player object is running the inter-base route R2, the stage corresponding composition MS02 corresponding to the base area A2 is repeatedly reproduced and output as BGM. Before the reproduction of the stage corresponding composition MS02 is started, a BGM switching period is provided. During the switching period, control is performed to smooth the switching from the stage corresponding composition MS01 to the stage corresponding composition MS02.

For example, if the player object comes close to the base area A2 (e.g., if the player object reaches a predetermined position a predetermined distance closer to the stating point than the checkpoint CP1), the stage corresponding composition MS01 that is being reproduced may transition to the outro. If the stage corresponding composition MS01 that is being reproduced ends, the predictive track of the next stage corresponding composition MS02 corresponding to the base area A2 may be reproduced. The predictive track is repeatedly reproduced, and if the player object passes through the checkpoint CP1 of the base area A2 during the reproduction of the predictive track, the reproduction of the stage corresponding composition MS02 may be started.

After the player object passes through the checkpoint CP1 of the base area A2, and while the player object is running the inter-base route R2, the stage corresponding composition MS02 is repeatedly reproduced and output as BGM. If the player object comes close to the next base area A3 (e.g., if the player object reaches a predetermined position a predetermined distance closer to the stating point than the checkpoint CP2), similarly to the above, transition is made to a BGM switching period. If the player object passes through the checkpoint CP2, the reproduction of the stage corresponding composition MS03 corresponding to the next base area A3 is started. After the player object passes through the checkpoint CP2, and while the player object is running the inter-base route R3, the stage corresponding composition MS03 is repeatedly reproduced and output as BGM.

Further, if the player object comes close to the next base area A11 (e.g., if the player object reaches a predetermined position a predetermined distance closer to the stating point than the checkpoint CP3), transition is made to a BGM switching period. If the player object passes through the checkpoint CP3, the reproduction of a stage corresponding composition MS11 corresponding to the next base area A11 is started. After the player object passes through the checkpoint CP3, and while the player object takes a lap around the intra-base route C11, the stage corresponding composition MS11 is repeatedly reproduced and output as BGM.

As described above, in the fourth game, the player object passes through a plurality of inter-base routes, and the stage corresponding composition corresponding to a base area where the start position of each inter-base route is provided is output as BGM.

In the above embodiment, a single stage corresponding composition corresponding to a single base area is prepared. In another exemplary embodiment, a plurality of stage corresponding compositions corresponding to a single base area may be prepared. For example, a stage corresponding composition list in which a plurality of stage corresponding compositions corresponding to a single base area are arranged may be prepared in advance. If a stage corresponding composition is to be reproduced in the above first game, second game, or fourth game, any of the plurality of compositions included in the stage corresponding composition list may be selected and reproduced. In this case, the compositions included in the stage corresponding composition list may be reproduced in order. Any of the plurality of compositions included in the stage corresponding composition list may be randomly selected, and the selected compositions may be repeatedly reproduced.

For example, if the first game is performed on the course shown in FIG. 5, and while the player object is running the intra-base route CA2, any of a plurality of stage corresponding compositions MS02 included in the stage corresponding composition list may be selected and output as BGM.

If the fourth game is performed on the course shown in FIG. 12, and while the player object is running the inter-base route R1, any of a plurality of stage corresponding compositions MS01 included in the stage corresponding composition list may be selected and output as BGM.

As described above, in the exemplary embodiment, a game (e.g., the above first game) is performed in a first mode where a first type of racing game is performed by a player object and other movable objects on a plurality of types of courses at least including an intra-base route that is a route set in any of a plurality of base areas set on a field and an inter-base route set as a route connecting the base areas. While the player object is running an inter-base route, a composition included in a first playlist (e.g., the playlist PL_A1) selected based on a location in the inter-base route (e.g., the start position of the inter-base route; the base area A1) among a plurality of first types of playlists (e.g., the playlists PL_A1 to PL_A3) is reproduced as BGM. While the player object is running an intra-base route, a second type of composition selected based on a base area corresponding to the intra-base route (e.g., the stage corresponding composition MS01 corresponding to the base area A1) or a composition included in a second playlist (e.g., a plurality of stage corresponding compositions corresponding to the base area A1) among a plurality of second types of compositions (e.g., stage corresponding compositions) or a second type of playlist (e.g., a stage corresponding composition list) is reproduced as BGM.

Consequently, in a racing game where a race is performed on courses set at various locations on a field, it is possible to incorporate regionalities into the selection of BGM to be reproduced.

In the exemplary embodiment, in-game time is set. While the player object is running an inter-base route, and if the in-game time is a first period of time (e.g., a period of time other than night), a composition included in the first playlist is output as BGM. If the in-game time is a second period of time (e.g., a period of time at night), a composition included in a third playlist (e.g., the playlist PL_N) is output as BGM. Consequently, it is possible to select BGM in accordance with the period of time.

In the above embodiment, in a case where the in-game time is the first period of time (e.g., the period of time other than night), and while the player object is running an inter-base route, compositions are selected and reproduced in order from the first playlist (e.g., the playlists PL_A1 to PL_A3). In a case where the in-game time is the second period of time (e.g., the period of time at night), and while the player object is running an inter-base route, compositions are selected and reproduced in order from the third playlist (e.g., the playlist PL_N).

In another exemplary embodiment, while the player object is running an inter-base route, only a predetermined number of (one or more) compositions may be selected using the first playlist. After the predetermined number of compositions are reproduced, a composition may be selected using a fourth playlist. For example, while the player object is running an inter-base route, only the first composition may be selected using the first playlist (e.g., the playlist PL_A1). After the reproduction of the first composition ends, the second and subsequent compositions may be selected using the fourth playlist (e.g., the playlist PL_G that is the versatile playlist or a playlist different from the playlist PL_G).

For example, while the player object is running an inter-base route in the first game, and after a predetermined number of compositions included in the first playlist are reproduced as BGM, and if the in-game time is the above first period of time, a composition included in the fourth playlist may be reproduced as BGM. If the in-game time is the above second period of time, a composition included in the above third playlist may be reproduced as BGM.

In the exemplary embodiment, a game (e.g., the above third game) can be executed in a second mode where the player object is caused to run, regardless of a course on the field. If the in-game time is the first period of time in the second mode, a composition included in a fifth playlist (e.g., the playlist PL_F) is reproduced as BGM. If the in-game time is the second period of time, a composition included in a sixth playlist (e.g., the playlist PL_FN) is reproduced as BGM.

Consequently, both while the player object is racing against the other movable objects and while the player object is not racing against the other movable objects, it is possible to perform a game on a common field. It is possible to set BGM to be reproduced during the game in view of both a regionality and a period of time in accordance with the mode of the game to be executed.

In the exemplary embodiment, a game (e.g., the above fourth game) can be executed in a third mode where a second type of race is performed on a course at least including a plurality of continuous inter-base routes. In the third mode, while the player object is running each of the inter-base routes, a second type of composition or a composition included in the second playlist according to a base area corresponding to the start position of the inter-base route may be reproduced as BGM. Consequently, it is possible to output compositions according to a base area as BGM in succession.

In the exemplary embodiment, a game (e.g., the above second game) can be executed in a fourth mode where a third type of race is performed on a course where the player object and the other movable objects take a predetermined number of laps around an intra-base route. In the fourth mode, a second type of composition or a composition included in the second playlist according to a base area corresponding to an intra-base route may be reproduced as BGM.

### Details of Game Processes

Next, the details of game processes of the above games are described.

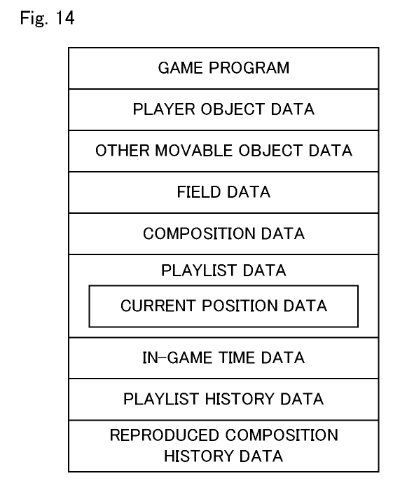

FIG. 14 is a diagram showing examples of various pieces of data used in the game processes. As shown in FIG. 14, a memory (e.g., the DRAM 27 or a storage medium or the flash memory 26 attached to the slot 29) of the game system 1 stores a game program, player object data, other movable object data, field data, composition data, playlist data, in-game time data, playlist history data, and reproduced composition history data.

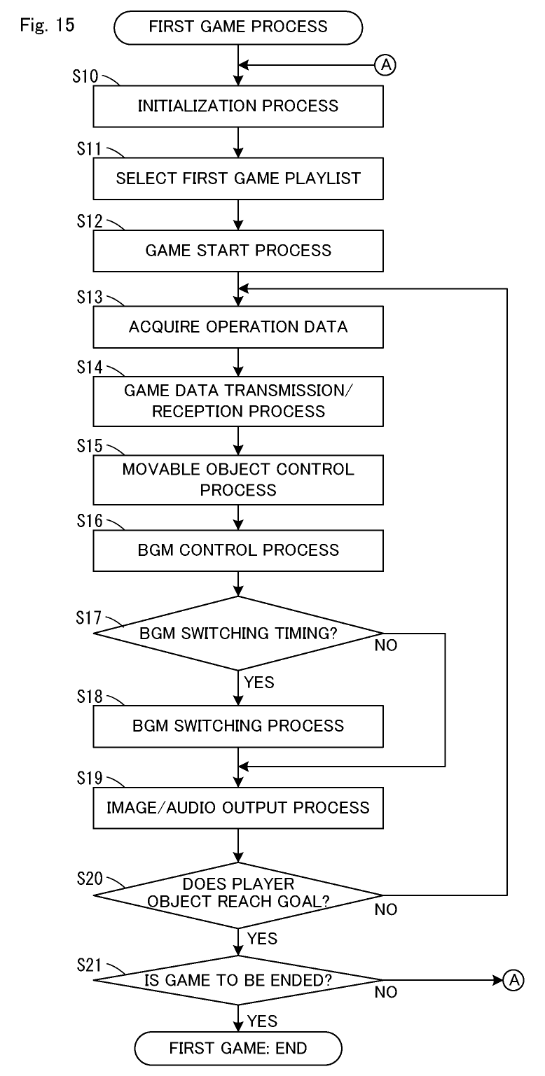

The game program is a program for executing the game processes of the games according to the exemplary embodiment (processes shown in FIGS. 15 to 18 described below). The game program is stored in advance in the storage medium or the flash memory 26 attached to the slot 29 and is loaded into the DRAM 27 when the racing game is executed.

The player object data is data regarding the player object (the operating object) controlled by the player of the main body apparatus 2. For example, the player object data includes data indicating the shape of the player object and data indicating the position, the orientation, the velocity, the moving direction, and the like of the player object.

The other movable object data includes data regarding the other movable objects controlled by other players or the processor 21. The other movable object data includes data indicating the shape of each of the other movable objects, data indicating the position, the orientation, the velocity, the moving direction, and the like of each of the other movable objects. In a case where the game is performed in the online multiplay mode, the other movable object data is acquired from other main body apparatuses.

The field data is data indicating the entirety of the field. The field data includes data indicating a plurality of base areas and data indicating a plurality of inter-base routes.

The composition data is data regarding compositions to be output as BGM. The composition data includes data regarding each of the plurality of compositions included in the first game playlist, data regarding each of a plurality of stage corresponding compositions, and data regarding each of the plurality of compositions included in the third game playlist.

The playlist data includes data indicating each of the plurality of first game playlists (e.g., the playlists PL_A1 to A3, the playlist PL_G, and the playlist PL_N) and data indicating each of the plurality of third game playlists (e.g., the playlists PL_F and PL_FN). Each playlist includes current position data. The current position data is data indicating the position of a composition to be output as BGM and is data indicating a row number in the playlist. A composition identified by the current position data of a selected playlist is reproduced and output as BGM. If the reproduction of the composition identified by the current position data ends, the current position data is updated. Specifically, the row number stored as the current position data is incremented. In a case where the row number stored as the current position data is the last row number of the playlist, and if the reproduction of a composition having the last row number ends, a composition having a row number 1 is selected and reproduced.

The in-game time data is data indicating in-game time. If the game is performed in the multiplay mode using a plurality of main body apparatuses 2, the in-game time data is shared by the plurality of main body apparatuses 2.

The playlist history data is data indicating the history of playlists used in the first game most recently performed a predetermined number of times.

The reproduced composition history data is data indicating the history of a predetermined number of compositions most recently reproduced as BGM. For example, 10 compositions most recently reproduced as BGM may be stored as the reproduced composition history data.

The game system 1 also stores various other pieces of data in addition to the data shown in FIG. 14.

Next, the details of the game processes regarding the games performed in the game system 1 are described. Before the game processes regarding the games are started, a game selection process for selecting the type of a game to be executed and a course where a race is performed is performed. In the game selection process, while causing a plurality of screens to transition, the player selects the type of a game and a course where a race is performed. Specifically, in the game selection process, based on an operation of the player, the player selects which of the above first to fourth games is to be performed. In the game selection process, based on an operation of the player, the player also selects in which of the single-play mode and the multiplay mode the selected game is to be performed. In the game selection process, if the type of a game is selected, based on an operation of the player, the player selects any of a plurality of courses according to the type of the game. In the game selection process, the player may select the types of a player object and a vehicle object to be used by the player.

With reference to FIGS. 15 to 18, the game processes regarding the games selected in the game selection process are specifically described below.

In the exemplary embodiment, the description is given on the assumption that the processes of steps shown in FIGS. 15 to 18 are executed by the processor 21 of the main body apparatus 2 executing the game program using a memory (e.g., the DRAM 27). In another exemplary embodiment, however, some of the processes of the steps may be executed by a processor (e.g., a dedicated circuit or the like) different from the processor 21. In a case where the game system 1 can communicate with another information processing apparatus (e.g., a server), some of the processes of the steps may be executed by the other information processing apparatus. The processes of the steps may be executed by each of a plurality of main body apparatuses 2, or some of the processes of the steps may be executed by any of the plurality of main body apparatuses 2. The processes of all of the steps are merely illustrative. Thus, the processing order of the steps may be changed, or another process may be performed in addition to (or instead of) the processes of all of the steps, so long as similar results are obtained.

### First Game Process

FIG. 15 is a flow chart showing an example of a first game process regarding the first game. The first game process is executed if the first game is selected by the player in the game selection process. Here, a case is described where the first game is executed in the online multiplay mode.

First, the processor 21 executes an initialization process (step S10). In the initialization process, the processor 21 sets a course selected by the player. For example, if the course including the inter-base route R1 and the intra-base route CA2 shown in FIG. 5 is selected as the course of the first game by the player, the processor 21 sets the course. In the initialization process, the processor 21 also exchanges various pieces of information with other main body apparatuses 2. For example, information regarding the type of the player object, information regarding the course where the first game is performed, information regarding in-game time, and the like are exchanged. For example, any of a plurality of main body apparatuses 2 may set in-game time, and the set in-game time may be shared by the other main body apparatuses 2. Alternatively, a server may set in-game time, and the in-game time set by the server may be shared by the main body apparatuses 2.

Next, the processor 21 selects the first game playlist (step S11). Here, the processor 21 selects the first game playlist according to the set course. Specifically, if the in-game time is nighttime, the processor 21 selects the playlist PL_N as the first game playlist. If the in-game time is other than nighttime, the processor 21 selects the base corresponding playlist corresponding to a base area including a starting point of the set course as the first game playlist. For example, if the course including the inter-base route R1 and the intra-base route CA2 shown in FIG. 5 is set, the processor 21 selects the playlist PL_A1 corresponding to the base area A1 including the starting point as the first game playlist. If the base corresponding playlist corresponding to the base area A including the starting point is not present, the processor 21 selects the playlist PL_G (the versatile playlist) as the first game playlist. Even if the base corresponding playlist corresponding to the base area A including the starting point is present, but if the base corresponding playlist is included in the playlist history data stored in the memory (e.g., if the base corresponding playlist is selected a predetermined number of times in succession in the first game most recently performed multiple times), the processor 21 selects the playlist PL_G (the versatile playlist) as the first game playlist.

Next, the processor 21 performs a game start process (step S12). In the game start process, the processor 21 places the player object corresponding to the main body apparatus 2 and a plurality of other movable objects corresponding to the other main body apparatuses 2 at the starting point. In the game start process, the processor 21 also selects any composition included in the first game playlist selected in step S11. For example, if current position data corresponding to the selected first game playlist is not set (e.g., if BGM is selected using the first game playlist for the first time after the first game is started), the processor 21 sets current position data corresponding to the first game playlist, thereby selecting any of the plurality of compositions included in the first game playlist. The selected first game playlist and the current position data are shared by the plurality of main body apparatuses 2. For example, a particular main body apparatus among the plurality of main body apparatuses 2 randomly determines a row number and sets the determined row number as current position data in the memory. The particular main body apparatus transmits the first game playlist and the current position data to the other main body apparatuses. The other main body apparatuses each store the first game playlist and the current position data received from the particular main body apparatus in the memory. Consequently, any of the plurality of compositions included in the first game playlist is selected in the other main body apparatuses. If current position data corresponding to the first game playlist is already set in the memory, the processor 21 updates the current position data and selects the next composition included in the first game playlist. Specifically, the processor 21 increments the row number indicated by the current position data, thereby selecting the composition having the next row number. The updated current position data is shared by the plurality of main body apparatuses 2. If the game start process ends, the processor 21 starts the first game and also starts the reproduction of the selected composition. If the first game is started, the processor 21 repeatedly executes the processes of steps S13 to S20 at predetermined frame time intervals (e.g., 1/60-second intervals) next.

In step S13, the processor 21 acquires the operation data. The processor 21 repeatedly acquires the operation data from the controllers 3 and 4 connected to the main body apparatus 2 at predetermined time intervals (e.g., 1/200-second intervals) and stores the operation data in the memory. In step S13, the processor 21 acquires the operation data stored in the memory.

Next, the processor 21 performs a game data transmission/reception process (step S14). Here, the processor 21 transmits game data regarding the player object to the other main body apparatuses 2 and receives game data regarding each of the other movable objects from the other main body apparatuses 2. The game data regarding the player object includes data indicating the position, the orientation, the velocity, the moving direction, and the like of the player object. The game data regarding each of the other movable objects includes data indicating the position, the orientation, the velocity, the moving direction, and the like of the other movable object.

Next, the processor 21 performs a movable object control process (step S15). Here, the processor 21 controls the plurality of movable objects including the player object and the other movable objects. Specifically, the processor 21 updates the position, the orientation, the velocity, the moving direction, and the like of the player object based on the operation data. The processor 21 also updates the position, the orientation, the velocity, the moving direction, and the like of each of the other movable objects based on the game data received from the other main body apparatuses 2.

Next, the processor 21 performs a BGM control process (step S16). Here, the processor 21 advances the reproduction time of the composition that is being reproduced by one frame time. In a case where the player object is running an inter-base route R (i.e., in a case where the first game playlist is used to select BGM), and if the composition that is being reproduced ends, the processor 21 increments the row number indicated by the current position data of the first game playlist, thereby selecting the composition having the next row number. Then, the processor 21 starts the reproduction of the composition having the next row number. In a case where the player object is running an intra-base route CA (i.e., in a case where a stage corresponding composition is being reproduced), and if the stage corresponding composition that is being reproduced ends, the processor 21 starts the reproduction of the stage corresponding composition again.

In a case where the player object is running an inter-base route R, there is a case where the processor 21 changes the first game playlist based on the in-game time when the composition that is being reproduced ends. For example, in a case where any of the playlists PL_A1 to A3 is selected as the first game playlist, and if the in-game time when the composition that is being reproduced ends is changed to night, the processor 21 changes the first game playlist to the playlist PL_N. In a case where the playlist PL_N is selected as the first game playlist, and if the in-game time when the composition that is being reproduced ends is changed to morning, the processor 21 changes the first game playlist to the base corresponding playlist corresponding to the base area A including the starting point (e.g., any of the playlists PL_A1 to A3). Then, the processor 21 selects any of the plurality of compositions included in the changed first game playlist and starts the reproduction of the selected composition. For example, if current position data corresponding to the changed first game playlist is not set (e.g., if BGM is selected using the first game playlist for the first time after the first game is started), the processor 21 randomly determines a row number and sets the determined row number as current position data in the memory, thereby selecting any of the plurality of compositions included in the first game playlist. If current position data corresponding to the changed first game playlist is set, the processor 21 increments the row number indicated by the current position data, thereby selecting the composition having the next row number. Then, the processor 21 starts the reproduction of the selected composition.

Next, the processor 21 determines whether or not the current time is a BGM switching timing (step S17). Here, in a case where BGM is being selected using the first game playlist, the processor 21 determines whether or not the current time is a timing when the BGM is to be changed to a stage corresponding composition. For example, if the player object reaches a predetermined position closer to the starting point than the next base area A2, the determination of the processor 21 may be YES in step S17. If the player object reaches a predetermined position in the next base area A2 (e.g., the gate of the intra-base route CA2), the determination of the processor 21 may be YES in step S17.

If it is determined that the current time is a BGM switching timing (step S17: YES), the processor 21 performs a BGM switching process (step S18). Specifically, the processor 21 ends the BGM that is being reproduced, and starts the reproduction of the stage corresponding composition corresponding to the next base area A. For example, if the player object reaches the base area A2, the processor 21 starts the reproduction of the stage corresponding composition MS02 corresponding to the base area A2. In the BGM switching process, before the composition included in the first game playlist is switched to the stage corresponding composition MS02, the processor 21 may reproduce the predictive track of the stage corresponding composition MS02.

If the process of step S18 is executed, or if the determination is NO in step S17, the processor 21 performs an image/audio output process (step S19). Here, the processor 21 generates a game image based on a virtual camera and outputs the generated image to a display. The processor 21 also outputs a sound including the BGM that is being reproduced from a speaker.

Next, the processor 21 determines whether or not the player object reaches a goal set on an intra-base route (step S20). For example, the processor 21 determines whether or not the player object takes a predetermined number of laps around the intra-base route CA2 and reaches the gate of the intra-base route CA2.

If the player object does not reach the goal (step S20: NO), the processor 21 executes the process of step S13 again.

If the player object reaches the goal (step S20: YES), the processor 21 determines whether or not to end the first game (step S21). Here, the processor 21 determines whether or not the player gives an instruction to end the first game.

If it is determined that the first game is not to be ended (step S21: NO), the processor 21 executes the process of step S10 again. Consequently, a course where the first game is performed next is selected based on an operation of the player, and the first game is performed again.

If it is determined that the first game is to be ended (step S21: YES), the processor 21 ends the first game. When the first game is ended, the current position data of each first game playlist is held to reproduce BGM next in another game mode. In another form, when the first game is ended, the current position data may be cleared.

### Second Game Process

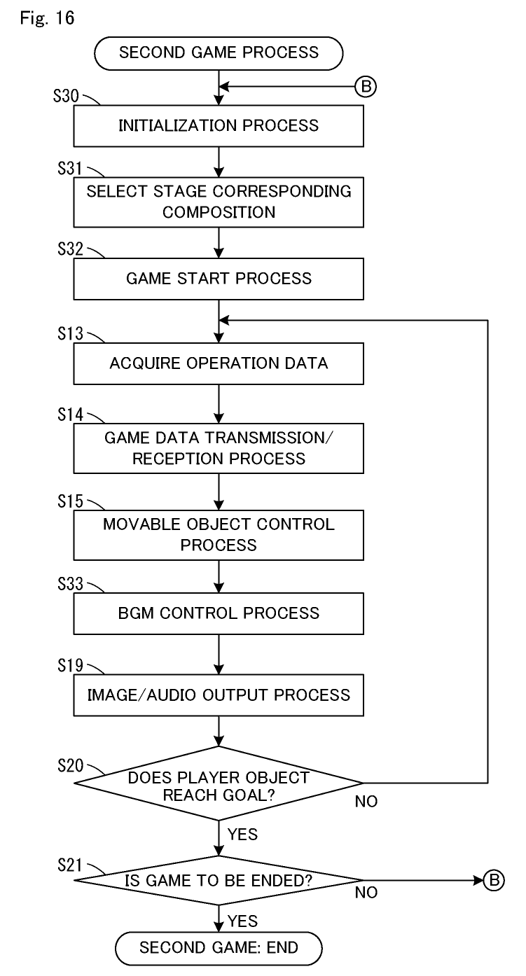

Next, a second game process related to the second game is described. FIG. 16 is a flow chart showing an example of the second game process regarding the second game. The second game process is executed if the second game is selected by the player in the game selection process. Here, a case is described where the second game is executed in the online multiplay mode. In FIG. 16, processes different from FIG. 15 are mainly described, and processes similar to those in FIG. 15 are designated by the same step numbers, and are not described in detail.

First, the processor 21 executes an initialization process (step S30). In the initialization process in step S30, any of the plurality of base areas A is selected based on an operation of the player, and a course where the plurality of movable objects take multiple laps around the intra-base route CA in the selected base area is set. In step S30, the processor 21 also exchanges various pieces of information with other main body apparatuses 2. For example, information regarding the type of the player object, information regarding the course where the second game is performed, information regarding in-game time, and the like are exchanged. For example, any of a plurality of main body apparatuses 2 may set in-game time, and the set in-game time may be shared by the other main body apparatuses 2. Alternatively, a server may set in-game time, and the in-game time set by the server may be shared by the main body apparatuses 2.

Next, the processor 21 selects the stage corresponding composition corresponding to the set course (step S31). For example, if a course where the plurality of movable objects take multiple laps around the intra-base route CA1 is set, the processor 21 selects the stage corresponding composition MS01.

Next, the processor 21 performs a game start process (step S32). In the game start process, the processor 21 places the player object corresponding to the main body apparatus 2 and a plurality of other movable objects corresponding to the other main body apparatuses 2 at a starting point. If the game start process ends, the processor 21 starts the second game and also starts the reproduction of the selected stage corresponding composition MS01. If the second game is started, the processor 21 repeatedly executes the processes of steps S13 to S20 at predetermined frame time intervals (e.g., 1/60-second intervals) next.

Next, the processor 21 executes the processes of steps S13 to S15. These processes are similar to the processes of steps S13 to S15 in FIG. 15.

After the process of S15, the processor 21 performs a BGM control process (step S33). Here, the processor 21 advances the reproduction time of the stage corresponding composition that is being reproduced by one frame time. If the stage corresponding composition that is being reproduced ends, the processor 21 starts the reproduction of the stage corresponding composition again.

After the process of S33, the processor 21 executes the process of step S19 similar to that in FIG. 15.

Next, the processor 21 determines whether or not the player object reaches a goal set on an intra-base route (step S20). If the player object does not reach the goal, the processor 21 executes the process of step S13 again. If the player object reaches the goal (step S20: YES), the processor 21 determines whether or not to end the second game (step S21). If it is determined that the second game is not to be ended, the processor 21 executes the process of step S30 again. If it is determined that the second game is to be ended (step S21: YES), the processor 21 ends the second game.

### Third Game Process

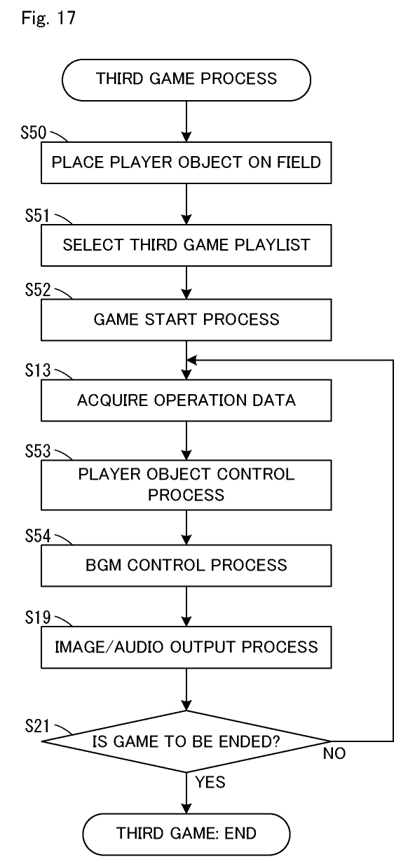

Next, a third game process related to the third game is described. FIG. 17 is a flow chart showing an example of the third game process regarding the third game. The third game process is executed if the third game is selected by the player in the game selection process. Here, the third game is executed in the single-play mode. In FIG. 17, processes different from FIG. 15 are mainly described, and processes similar to those in FIG. 15 are designated by the same step numbers, and are not described in detail.

First, the processor 21 places the player object on the field (step S50). For example, the processor 21 places the player object at a position on the field according to an operation of the player. In step S50, the processor 21 also sets in-game time.

Next, the processor 21 selects the third game playlist (step S51). Here, if the in-game time is nighttime, the processor 21 selects the playlist PL_FN as the third game playlist. If the in-game time is other than nighttime, the processor 21 selects the playlist PL_F as the third game playlist.

Next, the processor 21 performs a game start process (step S52). In the game start process, the processor 21 selects any composition included in the third game playlist selected in step S51. For example, if current position data corresponding to the selected third game playlist is not set (e.g., if BGM is selected using the third game playlist for the first time after the game is started), the processor 21 randomly determines a row number and sets current position data corresponding to the third game playlist, thereby selecting any of the plurality of compositions included in the third game playlist. If current position data corresponding to the third game playlist is already set in the memory, the processor 21 increments the row number indicated by the current position data, thereby selecting the composition having the next row number. If the game start process ends, the processor 21 starts the third game and also starts the reproduction of the selected composition. If the third game is started, the processor 21 repeatedly executes the processes of steps S13 to S21 at predetermined frame time intervals (e.g., 1/60-second intervals) next.

Next, the processor 21 executes the process of step S13 similar to that in FIG. 15.

After the process of S13, the processor 21 performs a player object control process (step S53). Here, the processor 21 updates the position, the orientation, the velocity, the moving direction, and the like of the player object based on the operation data.

After the process of S53, the processor 21 performs a BGM control process (step S54). Here, the processor 21 advances the reproduction time of the composition that is being reproduced by one frame time. If the composition that is being reproduced ends, the processor 21 increments the row number indicated by the current position data of the third game playlist, thereby selecting the composition having the next row number. Then, the processor 21 starts the reproduction of the composition having the next row number.

There is a case where the processor 21 changes the third game playlist based on the in-game time when the composition that is being reproduced ends. For example, in a case where the playlist PL_F is selected as the third game playlist, and if the in-game time when the composition that is being reproduced ends is changed to night, the processor 21 changes the third game playlist to the playlist PL_FN. In a case where the playlist PL_FN is selected as the third game playlist, and if the in-game time when the composition that is being reproduced ends is changed to morning, the processor 21 changes the third game playlist to the playlist PL_F. Then, the processor 21 selects any of the plurality of compositions included in the changed third game playlist and starts the reproduction of the selected composition. For example, if current position data corresponding to the changed third game playlist is not set (e.g., if BGM is selected using the third game playlist for the first time after the game is started), the processor 21 randomly determines a row number and sets the determined row number as current position data in the memory, thereby selecting any of the plurality of compositions included in the third game playlist. If current position data corresponding to the changed third game playlist is set, the processor 21 increments the row number indicated by the current position data, thereby selecting the composition having the next row number. Then, the processor 21 starts the reproduction of the selected composition.

After the process of S54, the processor 21 executes the process of step S19 similar to that in FIG. 15.

Next, for example, based on an operation of the player, the processor 21 determines whether or not to end the third game (step S21). If it is determined that the third game is not to be ended, the processor 21 executes the process of step S13 again. If it is determined that the third game is to be ended (step S21: YES), the processor 21 ends the third game. When the third game is ended, the current position data of each third game playlist is held to reproduce BGM next in another game mode. In another form, when the third game is ended, the current position data may be cleared.

### Fourth Game Process

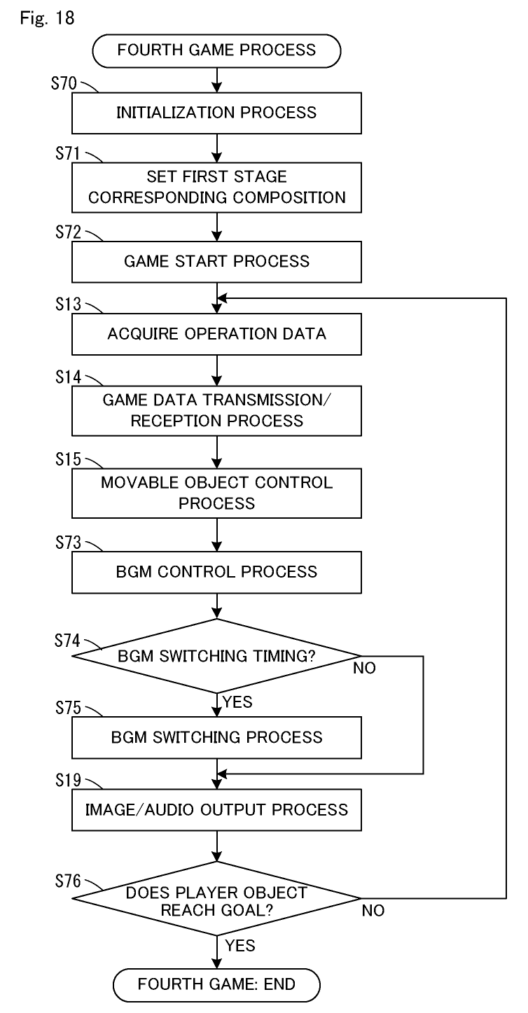

Next, a fourth game process related to the fourth game is described. FIG. 18 is a flow chart showing an example of the fourth game process regarding the fourth game. The fourth game process is executed if the fourth game is selected by the player in the game selection process. Here, a case is described where the fourth game is executed in the online multiplay mode. In FIG. 18, processes different from FIG. 15 are mainly described, and processes similar to those in FIG. 15 are designated by the same step numbers, and are not described in detail.

First, the processor 21 executes an initialization process (step S70). In the initialization process in step S70, based on an operation of the player, the processor 21 sets a course where the plurality of movable objects pass through a plurality of inter-base routes R and take a predetermined number of laps around an intra-base route CA that the plurality of movable objects reach last. Here, the course shown in FIG. 12 is set among a plurality of courses based on an operation of the player. In step S70, the processor 21 also exchanges various pieces of information with other main body apparatuses 2. For example, information regarding the type of the player object, information regarding the course where the fourth game is performed, information regarding in-game time, and the like are exchanged. For example, any of a plurality of main body apparatuses 2 may set in-game time, and the set in-game time may be shared by the other main body apparatuses 2. Alternatively, a server may set in-game time, and the in-game time set by the server may be shared by the main body apparatuses 2.

Next, the processor 21 selects the first stage corresponding composition of the set course (step S71). Specifically, the processor 21 selects the stage corresponding composition corresponding to a starting point of the set course. For example, if the fourth game is performed using the course shown in FIG. 12, the processor 21 selects the stage corresponding composition MS01 as the first stage corresponding composition.

Next, the processor 21 performs a game start process (step S72). In the game start process, the processor 21 places the player object corresponding to the main body apparatus 2 and a plurality of other movable objects corresponding to the other main body apparatuses 2 at the starting point. If the game start process ends, the processor 21 starts the fourth game and also starts the reproduction of the selected stage corresponding composition MS01. If the fourth game is started, the processor 21 repeatedly executes the processes of steps S13 to S76 at predetermined frame time intervals (e.g., 1/60-second intervals) next.

Next, the processor 21 executes the processes of steps S13 to S15. These processes are as shown in FIG. 15.

After the process of S15, the processor 21 performs a BGM control process (step S73). Here, the processor 21 advances the reproduction time of the stage corresponding composition that is being reproduced by one frame time. If the stage corresponding composition that is being reproduced ends, the processor 21 starts the reproduction of the stage corresponding composition again.

After the process of S73, the processor 21 determines whether or not the current time is a BGM switching timing (step S74). For example, the processor 21 determines whether or not the player object is located within a predetermined range including a checkpoint CP of the next base area (e.g., within a predetermined distance from a position closer to the starting point than the checkpoint CP).

If it is determined that the current time is a BGM switching timing (step S74: YES), the processor 21 performs a BGM switching process (step S75). For example, in the BGM switching process, the processor 21 causes the stage corresponding composition that is being reproduced to transition to the outro. For example, in a case where the player object is running the inter-base route R1, and if the player object reaches a predetermined position closer to the starting point than the checkpoint CP1 of the next base area A2, the processor 21 causes the stage corresponding composition MS01 that is being reproduced to transition to the outro. If time elapses after the stage corresponding composition MS01 is caused to transition to the outro, and the stage corresponding composition MS01 ends, the processor 21 reproduces the predictive track of the next stage corresponding composition MS02 corresponding to the base area A2. If the player object passes through the checkpoint CP1 of the next base area A2 during the reproduction of the outro of the stage corresponding composition MS01 or during the reproduction of the predictive track of the next stage corresponding composition MS02, the processor 21 ends the stage corresponding composition MS01 or the predictive track that is being reproduced, and starts the reproduction of the next stage corresponding composition MS02. The predictive track is reproduced in a loop manner until the reproduction of the stage corresponding composition MS02 is started. In another form, if the predictive track having a fixed length ends, the reproduction of the stage corresponding composition MS02 may be started.

If the process of step S75 is executed, or if the determination is NO in step S74, the processor 21 executes the process of step S19 similar to that in FIG. 15.

After the process of S19, the processor 21 determines whether or not the player object reaches a goal (step S76). If the player object reaches the goal (step S76: YES), the processor 21 ends the fourth game process. If the player object does not reach the goal (step S76: NO), the processor 21 executes the process of step S13 again. Here, the description has been given based on the premise that the player object passes through each checkpoint CP and takes a predetermined number of laps around the last intra-base route. When the player object reaches each checkpoint, based on the ranking of the player object when the player object reaches the checkpoint, it is determined whether or not to cause the player object to drop out of the fourth game. If the ranking of the player object when the player object reaches each checkpoint is lower than a predetermined ranking, the player object does not pass through the checkpoint and is caused to drop out of the fourth game. This is the description of FIG. 18.

The processes shown in the above flow charts are merely illustrative, and the order and the contents of the processes, and the like may be appropriately changed.

As described above, in the exemplary embodiment, in a first game, a plurality of movable objects including a player object perform a racing game on a course where the plurality of movable objects start from a base area, pass through an inter-base route R, reach another base area, and take a predetermined number of laps around an intra-base route provided in the other base area. In the first game, while the player object is running an inter-base route R, any of a plurality of compositions included in a first game playlist (a base corresponding playlist) corresponding to a base area where a starting point is provided is output as BGM. While the player object is running an intra-base route, a stage corresponding composition corresponding to the base area is output as BGM.

In a second game, the plurality of movable objects including the player object perform a racing game on a course where the plurality of movable objects take a predetermined number of laps around an intra-base route. In the second game, while the player object is taking a lap around an intra-base route in a base area, a stage corresponding composition corresponding to the base area is output as BGM.

In a third game, the player object freely moves on a field. During the third game, any of a plurality of compositions included in a third game playlist is output as BGM, regardless of the position of the player object.

In a fourth game, the plurality of movable objects including the player object perform a racing game on a course where the plurality of movable objects start from a base area, pass through a plurality of continuous inter-base routes R, and take a predetermined number of laps around an intra-base route in a base area that the plurality of movable objects reach last. In the fourth game, while the player object is running each inter-base route R, a stage corresponding composition corresponding to the start position (a starting point or a checkpoint) of the inter-base route R is output as BGM.

In addition to the above first to fourth games, a fifth game may be performed. For example, the fifth game is a racing game performed in the online multiplay mode. In the fifth game, the plurality of movable objects including the player object race on a course including inter-base routes R and intra-base routes CA. Specifically, in the fifth game, a plurality of races are performed on the course including the inter-base routes R and the intra-base routes CA. In the fifth game, the plurality of movable objects pass through a plurality of different base areas and reach the last base area. For example, the fifth game includes a first race, a second race, and a third race. For example, in the first race, the plurality of movable objects including the player object take multiple laps around the intra-base route CA1 in the base area A1 and reach a goal. In the second race, the plurality of movable objects including the player object start from the base area A1 that the plurality of movable objects have reached, pass through the inter-base route R1, and reach a goal provided in the base area A2. In the third race, the plurality of movable objects including the player object start from the base area A2 that the plurality of movable objects have reached, pass through the inter-base route R2, and reach a goal provided in the base area A3.

During the execution of the fifth game, BGM may be selected similarly to the first game. For example, in a case where the first race is performed, and while the player object is running the inter-base route R1, a composition included in the playlist PL_A1 corresponding to the base area A1 may be output as BGM. While the player object is running the intra-base route CA2, the stage corresponding composition MS02 corresponding to the base area A2 may be output as BGM. When in-game time is night, and while the player object is running the inter-base route R1, a composition included in the playlist PL_N may be output as BGM.

During the execution of the fifth game, BGM is output based on a fifth game playlist. Specifically, while the plurality of races including the first race are performed, compositions included in the fifth game playlist may be reproduced in the order of the list and output as BGM.

### Variations

While the exemplary embodiment has been described above, the exemplary embodiment is merely an example and may be modified as follows, for example.

For example, in the above embodiment, in the first game, while the player object is running an inter-base route R, BGM is selected using the first game playlist (the base corresponding playlist) selected based on the start position of the inter-base route R. The base corresponding playlist may be selected based not only on the start position, and but also on the location of the inter-base route R on the field.

In the above embodiment, in the first game, while the player object is running an inter-base route R, a composition included in the first game playlist is output as BGM. After the player object passes through an inter-base route R and while the player object is running an intra-base route CA, a stage corresponding composition is output as BGM. In another exemplary embodiment, in the first game, also after the player object passes through an inter-base route R and while the player object is running an intra-base route CA, a composition selected from among the first game playlist may be output as BGM.

In the above embodiment, as the first game playlist and the third game playlist, a playlist used when the in-game time is the first period of time (e.g., a period of time other than night) and a playlist used when the in-game time is the second period of time (e.g., a period of time at night) are prepared, and a composition according to the in-game time is not prepared as a stage corresponding composition. In another exemplary embodiment, also as a stage corresponding composition, a first stage corresponding composition used in a case where the in-game time is the first period of time and a second stage corresponding composition used in a case where in-game time is the second period of time may be prepared.

In the above embodiment, the third game is executed by a single main body apparatus 2, and only the player object corresponding to the player of the main body apparatus 2 is placed in the virtual space and runs on the field. In the third game, a plurality of main body apparatuses 2 may communicate with each other (e.g., via the Internet), and a player object corresponding to each of players of the plurality of main body apparatuses 2 may be placed in the same virtual space and run on the field. In this case, the in-game time may be shared by the plurality of main body apparatuses 2. The third game playlist and the current position data may also be shared by the plurality of main body apparatuses 2. For example, a particular main body apparatus among the plurality of main body apparatuses 2 may set the third game playlist and the current position data and transmit the third game playlist and the current position data to the other main body apparatuses. Consequently, it is possible to output common BGM in the third game executed by each of the plurality of players.

In the above embodiment, if the fourth game is performed, the stage corresponding composition corresponding to each base area is output as BGM. In another exemplary embodiment, in a case where the fourth game is performed, and while the player object is running an inter-base route, BGM may be selected based on a fourth game playlist in which a plurality of compositions are arranged. The fourth game playlist may be the same as or different from the first game playlist. The fourth game playlist may be the same as or different from the third game playlist.

In the above embodiment, there is a case where the playlists (the first game playlists or the third game playlists) include the same composition. In another exemplary embodiment, the playlists may not include the same composition. In the above embodiment, a stage corresponding composition is not included in the playlists. In another exemplary embodiment, a stage corresponding composition may be included in the playlists.

In the above embodiment, if the first game is performed in the multiplay mode, a plurality of main body apparatuses communicate with each other, thereby sharing a selected first game playlist and current position data indicating a position in the first game playlist. Then, each main body apparatus reproduces a composition at the position indicated by the current position data in the first game playlist. The current position data may be reproduced part data indicating a part that is being reproduced in the first game playlist. The reproduced part data may be data indicating which composition in the first game playlist is being reproduced. The reproduced part data may be data indicating which composition in the first game playlist is being reproduced, and also indicating the reproduction position in the composition (a position from the beginning of the composition).

The methods used to select BGM in the above first to fourth games may be optionally combined together. A game program capable of executing at least any one of the first to fourth games may be configured.

For example, a game program capable of executing the first game and the third game may be configured, and in the first game, while the player object is running an inter-base route R, BGM may be selected using the first game playlist according to a location in the inter-base route R. In the third game where the player object is moved on the field without setting a path on which the player object moves, BGM may be selected using the third game playlist.

For example, a game program capable of executing the third game and the fourth game may be configured, and in the third game where the player object is moved on the field without setting a path on which the player object moves, BGM may be selected using the third game playlist. In the fourth game where a course including a plurality of continuous inter-base routes is set, while the player object is running each inter-base route, the stage corresponding composition corresponding to each base area may be output as BGM.

For example, a game program capable of executing the first game and the fourth game may be configured, and in the first game, while the player object is running an inter-base route R, BGM may be selected using the first game playlist according to a location in the inter-base route R. In the fourth game where a course including a plurality of continuous inter-base routes is set, while the player object is running each inter-base route, the stage corresponding composition corresponding to each base area may be output as BGM.

The above processing may be executed not only by the game system 1, but also by any other information processing apparatus or information processing system. The information processing system may include a plurality of apparatuses, and the plurality of apparatuses may be connected to each other via a network (e.g., a LAN, the Internet, or the like).

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage media having stored therein instructions that, when executed, cause one or more processors to perform operations comprising:
causing an operating object to run on a field in a virtual space based on an operation input; and
in a first mode where a first type of race is performed by the operating object and at least one other movable object on any of a plurality of types of courses at least including an intra-base route that is a path set in any of a plurality of base areas set on the field and an inter-base route set as a path connecting the base areas,
while the operating object is running the inter-base route, reproducing as BGM a composition included in a first playlist selected based on a location in the inter-base route among a plurality of first types of playlists, and
while the operating object is running the intra-base route, reproducing as BGM a second type of composition selected based on the base area corresponding to the intra-base route or a composition included in a second playlist among a plurality of second types of compositions or a second type of playlist.

2. The one or more non-transitory computer-readable storage media according to claim 1, wherein
the operations further comprise
in the first mode,
while the operating object is running the inter-base route,
when in-game time is a first period of time, reproducing as BGM a composition included in the first playlist, and
when the in-game time is a second period of time, reproducing as BGM a composition included in a third playlist.

3. The one or more non-transitory computer-readable storage media according to claim 2, wherein
the operations further comprise
in the first mode,
while the operating object is running the inter-base route, after reproducing a predetermined number of compositions included in the first playlist,
when the in-game time is the first period of time, reproducing as BGM a composition included in a fourth playlist, and
when the in-game time is the second period of time, reproducing as BGM a composition included in the third playlist.

4. The one or more non-transitory computer-readable storage media according to claim 1, wherein
the operations further comprise
selecting the first playlist in accordance with the base area corresponding to a start position of the inter-base route among the first types of playlists.

5. The one or more non-transitory computer-readable storage media according to claim 1, wherein
the operations further comprise
in a second mode where the operating object is caused to run on the field, regardless of a course,
if in-game period of time is a first period of time, reproducing as BGM a composition included in a fifth playlist, and
when the in-game period of time is a second period of time, reproducing as BGM a composition included in a sixth playlist.

6. The one or more non-transitory computer-readable storage media according to claim 1, wherein
the operations further comprise
in a third mode where a second type of race is performed on a course at least including the plurality of continuous inter-base routes,
while the operating object is running each of the inter-base routes, reproducing as BGM the second type of composition or a composition included in the second playlist according to the base area corresponding to a start position of the inter-base route.

7. The one or more non-transitory computer-readable storage media according to claim 1, wherein
the operations further comprise
in a fourth mode where a third type of race is performed on a course where the operating object and the at least one other movable object take a predetermined number of laps around the intra-base route,
reproducing as BGM the second type of composition or a composition included in the second playlist according to the base area corresponding to the intra-base route.

8. The one or more non-transitory computer-readable storage media according to claim 1, wherein
the operations further comprise:
controlling the at least one other movable object based on data of another player acquired based on communication to perform the first type of race as a competition against the other player; and
in the first type of race,
transmitting a playlist that is being selected and reproduced part data indicating a part that is being reproduced in the playlist, or reproducing the BGM based on the received reproduced part data.

9. An information processing system comprising:
one or more processors; and
one or more non-transitory computer-readable media storing instructions that, when executed, cause the one or more processors to perform operations comprising:
causing an operating object to run on a field in a virtual space based on an operation input; and
in a first mode where a first type of race is performed by the operating object and at least one other movable object on any of a plurality of types of courses at least including an intra-base route that is a path set in any of a plurality of base areas set on the field and an inter-base route set as a path connecting the base areas,
while the operating object is running the inter-base route, reproducing as BGM a composition included in a first playlist selected based on a location in the inter-base route among a plurality of first types of playlists, and
while the operating object is running the intra-base route, reproducing as BGM a second type of composition selected based on the base area corresponding to the intra-base route or a composition included in a second playlist among a plurality of second types of compositions or a second type of playlist.

10. The information processing system according to claim 9, wherein
the operations further comprise
in the first mode,
while the operating object is running the inter-base route,
when in-game time is a first period of time, reproducing as BGM a composition included in the first playlist, and
when the in-game time is a second period of time, reproducing as BGM a composition included in a third playlist.

11. The information processing system according to claim 10, wherein
the operations further comprise
in the first mode,
while the operating object is running the inter-base route, after reproducing a predetermined number of compositions included in the first playlist,
when the in-game time is the first period of time, reproducing as BGM a composition included in a fourth playlist, and
when the in-game time is the second period of time, reproducing as BGM a composition included in the third playlist.

12. The information processing system according to claim 9, wherein
the operations further comprise
selecting the first playlist in accordance with the base area corresponding to a start position of the inter-base route among the first types of playlists.

13. The information processing system according to claim 9, wherein
the operations further comprise
in a second mode where the operating object is caused to run on the field, regardless of a course,
when in-game period of time is a first period of time, reproducing as BGM a composition included in a fifth playlist, and
when the in-game period of time is a second period of time, reproducing as BGM a composition included in a sixth playlist.

14. The information processing system according to claim 9, wherein
the operations further comprise
in a third mode where a second type of race is performed on a course at least including the plurality of continuous inter-base routes,
while the operating object is running each of the inter-base routes, reproducing as BGM the second type of composition or a composition included in the second playlist according to the base area corresponding to a start position of the inter-base route.

15. The information processing system according to claim 9, wherein
the operations further comprise
in a fourth mode where a third type of race is performed on a course where the operating object and the at least one other movable object take a predetermined number of laps around the intra-base route,
reproducing as BGM the second type of composition or a composition included in the second playlist according to the base area corresponding to the intra-base route.

16. The information processing system according to claim 9, wherein
the operations further comprise:
controlling the at least one other movable object based on data of another player acquired based on communication to perform the first type of race as a competition against the other player; and
in the first type of race,
transmitting a playlist that is being selected and reproduced part data indicating a part that is being reproduced in the playlist, or reproducing the BGM based on the received reproduced part data.

17. A computer-implemented method comprising:
causing an operating object to run on a field in a virtual space based on an operation input; and
in a first mode where a first type of race is performed by the operating object and at least one other movable object on any of a plurality of types of courses at least including an intra-base route that is a path set in any of a plurality of base areas set on the field and an inter-base route set as a path connecting the base areas,
while the operating object is running the inter-base route, reproducing as BGM a composition included in a first playlist selected based on a location in the inter-base route among a plurality of first types of playlists, and
while the operating object is running the intra-base route, reproducing as BGM a second type of composition selected based on the base area corresponding to the intra-base route or a composition included in a second playlist among a plurality of second types of compositions or a second type of playlist.

18. The computer-implemented method according to claim 17, further comprising
in the first mode,
while the operating object is running the inter-base route,
when in-game time is a first period of time, reproducing as BGM a composition included in the first playlist, and
when the in-game time is a second period of time, reproducing as BGM a composition included in a third playlist.

19. The computer-implemented method according to claim 18, further comprising
in the first mode,
while the operating object is running the inter-base route, after reproducing a predetermined number of compositions included in the first playlist,
when the in-game time is the first period of time, reproducing as BGM a composition included in a fourth playlist, and
when the in-game time is the second period of time, reproducing as BGM a composition included in the third playlist.

20. The computer-implemented method according to claim 17, further comprising
selecting the first playlist in accordance with the base area corresponding to a start position of the inter-base route among the first types of playlists.

21. The computer-implemented method according to claim 17, further comprising
in a second mode where the operating object is caused to run on the field, regardless of a course,
when in-game period of time is a first period of time, reproducing as BGM a composition included in a fifth playlist, and
when the in-game period of time is a second period of time, reproducing as BGM a composition included in a sixth playlist.

22. The computer-implemented method according to claim 17, further comprising
in a third mode where a second type of race is performed on a course at least including the plurality of continuous inter-base routes,
while the operating object is running each of the inter-base routes, reproducing as BGM the second type of composition or a composition included in the second playlist according to the base area corresponding to a start position of the inter-base route.

23. The computer-implemented method according to claim 17, further comprising
in a fourth mode where a third type of race is performed on a course where the operating object and the at least one other movable object take a predetermined number of laps around the intra-base route,
reproducing as BGM the second type of composition or a composition included in the second playlist according to the base area corresponding to the intra-base route.

24. The computer-implemented method according to claim 17, further comprising:
controlling the at least one other movable object based on data of another player acquired based on communication to perform the first type of race as a competition against the other player; and
in the first type of race,
transmitting a playlist that is being selected and reproduced part data indicating a part that is being reproduced in the playlist, or reproducing the BGM based on the received reproduced part data.
